(19) United States
(12) Patent Application Publication
(10) Pub. No.: US 2015/0364767 A1
(43) Pub. Date: Dec. 17, 2015

(54) POROUS ELECTRODE ASSEMBLY, LIQUID-FLOW HALF-CELL, AND LIQUID-FLOW CELL STACK

(71) Applicant: DONGFANG ELECTRIC CORPORATION, Chengdu, Sichuan (CN)

(72) Inventors: Cong YIN, Chengdu, Sichuan (CN); Hao TANG, Chengdu, Sichuan (CN); Yanbin SONG, Chengdu, Sichuan (CN); Zhiwei LIU, Chengdu, Sichuan (CN); Yan GAO, Chengdu, Sichuan (CN); Yangyue HU, Chengdu, Sichuan (CN)

(73) Assignee: DONGFANG ELECTRIC CORPORATION, Chengdu, Sichuan (CN)

(21) Appl. No.: 14/765,175

(22) PCT Filed: Jan. 31, 2013
(86) PCT No.: PCT/CN2013/071239

§ 371 Date: Jul. 31, 2015

(51) Int. Cl. H01M 4/86; H01M 8/20; H01M 8/24; H01M 8/18

(52) U.S. Cl. CPC H01M 4/8626; H01M 8/188; H01M 8/20; H01M 8/2445

(57) ABSTRACT

The disclosure discloses a porous electrode assembly, a flow half-cell and a flow cell stack. The porous electrode assembly includes multiple porous electrodes which are stacked, wherein at least two porous electrodes are flow passage electrodes with flow passage, and a part of flow passages of at least two flow passage electrodes are mutually communicated to form a flow field. The flow field used for circulating an electrolyte and formed by communicating the flow passages one another is arranged in at least one porous electrode of the porous electrode assembly, and the electrolyte flows in the porous electrodes under a flow guide effect of the flow field, so that surface areas, permeated by the electrolyte, of solid parts of the porous electrodes are enlarged, flow resistance of the porous electrodes to the flowing of the electrolyte is reduced, and a flow pressure difference is reduced.

### TECHNICAL FIELD OF THE INVENTION

The disclosure relates to the field of flow cell design, and in particular to a porous electrode assembly, a flow half-cell and a flow cell stack.

### BACKGROUND OF THE INVENTION

An all-vanadium redox flow cell is an electrochemical reaction device for redox with vanadium ion electrolytes in different valance states, and can efficiently realize conversion between chemical energy and electric energy. Such a cell has the advantages of long service life, high energy conversion efficiency, high safety, environment friendliness and the like, can be used for a large-scale energy storage system matching wind power generation and photovoltaic power generation, and is one of main choices for peak clipping, valley filling and load balancing of a power grid. Therefore, all-vanadium redox flow cells gradually become the focus in high-capacity energy storage cell researches in recent years.

Vanadium ions V²⁺/V³⁺ and V⁴⁺/V⁵⁺ are taken as positive and negative redox couples of an all-vanadium redox flow cell respectively, positive and negative electrolytes are stored in two liquid storage tanks respectively, and the active electrolytes are driven by an acid-resistant liquid pump to flow to a reaction place (cell stack) and then return to the liquid storage tanks to form a circulating flow loop, thereby implementing a charging and discharging process. In an all-vanadium redox flow cell energy storage system, charging and discharging performance, particularly charging and discharging power and efficiency, of the whole system depends on performance of the cell stack. The cell stack is formed by sequentially stacking, tightly pressing and connecting multiple single cells in series. The structure of each flow cell is shown in FIG. 1. 1′ is a flow frame, 2′ is a bipolar plate, 3′ is a porous electrode, 4′ is an ion exchange membrane, the components form the single flow cells, and N flow cells are stacked into the cell stack 5′.

Electrolytes in an existing flow cell stack flow generally by virtue of infiltration mass transfer of the porous electrodes. On one hand, such a flowing manner may cause a great flow pressure difference in the cell stack and excessively high pump consumption, thereby reducing the efficiency of the flow cell system; and on the other hand, the flowing manner may cause flowing non-uniformity and greater concentration polarization of the electrolytes in the cell stack to further cause the internal loss of the cell stack, thereby reducing the voltage efficiency of the cells.

### SUMMARY OF THE INVENTION

The disclosure aims to provide a porous electrode assembly, a flow half-cell and a flow cell stack, which improve flowing uniformity of electrolytes in porous electrodes.

In order to achieve the purpose, according to an aspect of the disclosure, a porous electrode assembly is provided, which comprises multiple porous electrodes which are stacked, wherein at least two porous electrodes are flow passage electrodes with flow passage, and a part of flow passages of at least two flow passage electrodes are mutually communicated to form a flow field.

Furthermore, there are overlapping sections overlapping in a stacking direction of the porous electrodes between mutually communicated flow passages of adjacent flow passage electrodes.

Furthermore, there are one or more flow fields, and an extending direction of each flow passage in each flow field is the same.

Furthermore, there is one flow field, and the flow field is provided on a centre plane of the porous electrode assembly.

Furthermore, there are multiple flow fields, and the flow fields are arranged in manners as follows: A, each flow field is arranged in parallel with two ends closed, and distances between the two ends of each flow field and edges of the porous electrode assembly perpendicular to an extending direction of the flow field are the same; or B, each flow field is arranged in parallel with two ends closed, and adjacent flow fields are staggered along the extending direction of the flow passages; or C, each flow field is arranged in parallel with one end open, and opening directions of adjacent flow fields are the same or opposite; or D, the flow fields are divided into multiple flow field groups which are arranged in parallel, each flow field group comprises multiple flow fields, an extending direction of each flow field group is parallel to the extending direction of the flow passages in the flow field group, and the flow fields in adjacent flow field groups are staggered along the extending direction of the flow passages; or E, the flow fields are divided into multiple flow field groups which are arranged in parallel, each flow field group comprises multiple flow fields, an extending direction of each flow field group is perpendicular to the extending direction of the flow passages in the flow field group, and the flow fields in each flow field group are staggered along the extending direction of the flow passages.

Furthermore, the flow fields comprise one or more first flow fields formed by the flow passages with the same extending direction and one or more second flow fields perpendicular to an extending direction of the first flow field.

Furthermore, the flow fields are arranged in manners as follows: F, there are multiple first flow fields on the porous electrode assembly, the multiple first flow fields are divided into multiple first flow field groups, at least one second flow field is provided between every two adjacent first flow field groups, each first flow field group comprises multiple first flow fields which are arranged in parallel, and adjacent first flow fields are staggered along the extending direction of the flow passages of the first flow fields; or G, there are one or more T-shaped flow field groups on the porous electrode assembly, the T-shaped flow field group comprises a first flow field and a second flow field facing a middle part of the first flow field, the second flow field and the first flow field in the T-shaped flow field group are not communicated, and when there are multiple T-shaped flow field groups, in every two adjacent T-shaped flow field groups, two second flow fields are parallel to each other, two first flow fields are positioned at different ends of the corresponding second flow fields, and the adjacent T-shaped flow field groups are communicated or not communicated with one another; or H, there are one or more I-shaped flow field groups on the porous electrode assembly, the I-shaped flow field group comprises two first flow fields which are oppositely arranged in parallel and a second flow field of which two ends face middle parts of the two first flow fields respectively, the second flow fields is not communicated with the first flow field, and when there are multiple I-shaped flow field groups, the I-shaped flow field groups are communicated or not communicated with one another; or I, there are one or more Z-shaped flow field groups on the porous electrode assembly, the Z-shaped flow field group comprises two first flow fields and a second flow field, the two first flow fields are provided on two sides of the second flow field respectively, the two first flow fields are communicated with different end parts of the second flow field respectively, and when there are multiple Z-shaped flow field groups, the Z-shaped flow field groups are communicated or not communicated with one another; or J, there are one or more serpentine flow field groups of which two ends are open on the porous electrode assembly, the serpentine flow field group comprises multiple first flow fields and multiple second flow fields, the first flow fields and the second flow fields between the first flow fields and/or second flow fields at openings in the two ends are communicated end to end, and the serpentine flow field groups are communicated or not communicated; or K, there are one or more parallel flow field groups of which two ends are open on the porous electrode assembly, the parallel flow field group comprises two first flow fields and multiple second flow fields, and the second flow fields are provided between the first flow fields, and are communicated with the second flow fields.

According to another aspect of the disclosure, a flow half-cell is provided, which comprises: a flow borders, provided with borders and an electrode accommodation cavity formed by the borders, an electrolyte inlet and an electrolyte outlet being formed in the borders; a porous electrode assembly, embedded into the electrode accommodation cavity of the flow borders and communicated with the electrolyte inlet and the electrolyte outlet, the porous electrode assembly being the abovementioned porous electrode assembly; and a bipolar plate, provided on one side of the flow borders and in parallel with the porous electrode assembly.

Furthermore, there are overlapping sections overlapping in a stacking direction of porous electrodes of the porous electrode assembly between mutually communicated flow passages of adjacent flow passage electrodes of the porous electrode assembly.

Furthermore, in the porous electrode assembly, extending length of the overlapping section for an electrolyte to flow to the porous electrodes far away from the bipolar plate are greater than extending length of the overlapping section for the electrolyte to flow to the porous electrodes close to the bipolar plate.

Furthermore, the flow frame comprises a first border and a second border, which are opposite to each other, the electrolyte inlet is formed in the first border, the electrolyte outlet is formed in the second border, and gaps are formed between the porous electrode assembly and the first border and the second border.

Furthermore, a flow field of the porous electrode assembly is provided with an opening, and is perpendicular to the first border and the second border, and the gaps communicate the electrolyte inlet with the flow field and communicate the electrolyte outlet with the flow field.

Furthermore, an electrolyte flow guide inlet and an electrolyte flow guide outlet, which correspond to the electrolyte inlet and the electrolyte outlet, are formed in the bipolar plate.

According to another aspect of the disclosure, a flow cell stack is provided, which comprises one or more positive half-cells, one or more negative half-cells and an ion exchange membrane provided between the positive half-cell and the negative half-cell, wherein the positive half-cell and the negative half-cell are abovementioned flow half-cells, and bipolar plates of the flow half-cells are provided far away from the ion exchange membrane.

According to the technical solutions of the disclosure, the flow field used for circulating the electrolyte and formed by communicating the flow passages one another is provided in at least one porous electrode of the porous electrode assembly, and the electrolyte flows in the porous electrodes under a flow guide effect of the flow field, so that surface areas, permeated by the electrolyte, of solid parts of the porous electrodes are enlarged, flow resistance of the porous electrodes to the flowing of the electrolyte is reduced, and a flow pressure difference required by the flowing of the electrolyte is effectively reduced; and moreover, when the electrolyte flows in the flow field, the electrolyte uniformly permeates the porous electrodes on the two sides of the field flow, so that the flowing uniformity of the electrolyte is improved, concentration polarization caused by the flowing non-uniformity of the electrolyte is reduced, and the charging and discharging efficiency of the flow cell with the porous electrode assembly is improved.

### BRIEF DESCRIPTION OF THE DRAWINGS

The drawings in the Specification form a part of the disclosure, and are used for provide further understanding of the disclosure. The schematic embodiments and description of the disclosure are adopted to explain the disclosure, and do not form improper limits to the disclosure. In the drawings:

FIG. 1 shows a structure diagram of a flow cell in an existing technology;

FIG. 2 shows a structure diagram of a porous electrode assembly according to a preferred embodiment of the disclosure;

FIG. 3 shows a structure diagram of a porous electrode assembly according to another preferred embodiment of the disclosure;

FIG. 4a shows a structure diagram of a porous electrode assembly according to another preferred embodiment of the disclosure;

FIG. 4b shows a structure diagram of a porous electrode assembly according to another preferred embodiment of the disclosure;

FIG. 5a and FIG. 5b show a structure diagram of a porous electrode assembly according to another preferred embodiment of the disclosure;

FIG. 6 shows a structure diagram of a porous electrode assembly according to another preferred embodiment of the disclosure;

FIG. 7 shows a structure diagram of a porous electrode assembly according to another preferred embodiment of the disclosure;

FIG. 8 shows a structure diagram of a porous electrode assembly according to another preferred embodiment of the disclosure;

FIG. 9 shows a structure diagram of a porous electrode assembly according to another preferred embodiment of the disclosure;

FIG. 10 shows a structure diagram of a porous electrode assembly according to another preferred embodiment of the disclosure;

FIG. 11 shows a structure diagram of a porous electrode assembly according to another preferred embodiment of the disclosure;

FIG. 12a and FIG. 12b show a structure diagram of a porous electrode assembly according to another preferred embodiment of the disclosure;

FIG. 13a and FIG. 13b show a structure diagram of a porous electrode assembly according to another preferred embodiment of the disclosure;

FIG. 14 shows a structure diagram of a flow half-cell according to a preferred embodiment of the disclosure;

FIG. 15 shows a flowing diagram of an electrolyte in a porous electrode assembly of a flow half-cell according to another preferred embodiment of the disclosure, wherein the arrow points to a flowing direction of the electrolyte;

FIG. 16 shows a flowing diagram of an electrolyte in a porous electrode assembly of a flow half-cell according to another preferred embodiment of the disclosure, wherein the arrow points to a flowing direction of the electrolyte;

FIG. 17 shows a flowing diagram of an electrolyte in a porous electrode assembly of a flow half-cell according to another preferred embodiment of the disclosure, wherein the arrow points to a flowing direction of the electrolyte;

FIG. 18 shows a flowing diagram of an electrolyte in a porous electrode assembly of a flow half-cell according to another preferred embodiment of the disclosure, wherein the arrow points to a flowing direction of the electrolyte;

FIG. 19 shows a flowing diagram of an electrolyte in a porous electrode assembly of a flow half-cell according to another preferred embodiment of the disclosure, wherein the arrow points to a flowing direction of the electrolyte;

FIG. 20 shows a flowing diagram of an electrolyte in a porous electrode assembly of a flow half-cell according to another preferred embodiment of the disclosure, wherein the arrow points to a flowing direction of the electrolyte;

FIG. 21 shows a flowing diagram of an electrolyte in a porous electrode assembly of a flow half-cell according to another preferred embodiment of the disclosure, wherein the arrow points to a flowing direction of the electrolyte; and

FIG. 22 shows a flowing diagram of an electrolyte in a porous electrode assembly of a flow half-cell according to another preferred embodiment of the disclosure, wherein the arrow points to a flowing direction of the electrolyte.

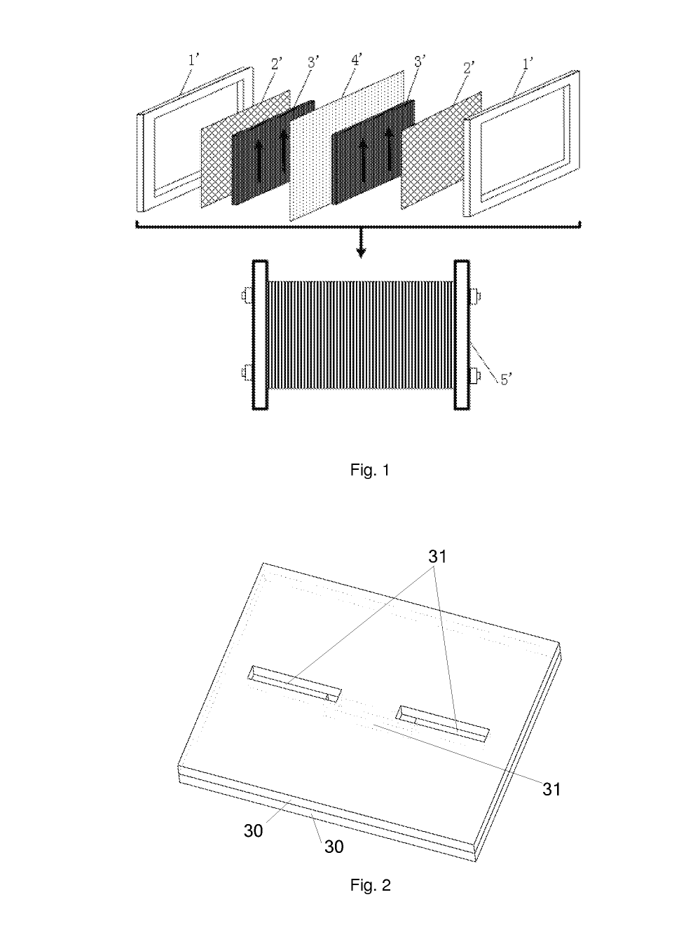

### DETAILED DESCRIPTION OF THE EMBODIMENTS

It is important to note that the embodiments in the disclosure and characteristics in the embodiments can be combined under the condition of no conflicts. The disclosure is described below with reference to the drawings and the embodiments in detail.

As shown in FIG. 2 to FIG. 13b, in a typical implementation mode of the disclosure, a porous electrode assembly is provided, which comprises multiple porous electrodes 30 which are stacked, wherein at least one porous electrode 30 is a flow passage electrode with flow passage 31, and a part of flow passages 31 of at least two flow passage electrodes are mutually communicated to form a flow field.

According to the porous electrode assembly with such a structure, the flow field used for circulating an electrolyte and formed by communicating the flow passages 31 one another is provided in at least one porous electrode 30 of the porous electrode assembly, and the electrolyte flows in the porous electrodes 30 under a flow guide effect of the flow field, so that surface areas, permeated by the electrolyte, of solid parts of the porous electrodes 30 are enlarged, flow resistance of the porous electrodes 30 to the flowing of the electrolyte is reduced, and a flow pressure difference required by the flowing of the electrolyte is effectively reduced; and moreover, when the electrolyte flows in the flow field, the electrolyte uniformly permeates the porous electrodes 30 on the two sides of the field flow, so that the flowing uniformity of the electrolyte is improved, concentration polarization caused by the flowing non-uniformity of the electrolyte is reduced, and the charging and discharging efficiency of a flow cell with the porous electrode assembly is improved.

In the disclosure, there are multiple manners for forming the flow field, there are also multiple manners for designing the flow passages 31, and when a part of flow passages 31 of adjacent flow passage electrodes are communicated to form the flow field in a stacking direction of the porous electrodes 30, the electrolyte can flow between different porous electrodes 30 under the flow guide effect of the flow field, so that the flowing uniformity of the electrolyte in the porous electrode assembly can be obviously improved.

Thicknesses of the porous electrodes 30 in the porous electrode assembly of the disclosure may be the same or different, porous electrode assemblies with different thickness proportions may cause different influence on a transmission direction of the electrolyte and mass transfer efficiency of the electrolyte in a local area, and those skilled in the art may optimize the thicknesses of the porous electrodes 30 according to a requirement on the mass transfer efficiency.

In a preferred embodiment of the disclosure, there are overlapping sections overlapping in a stacking direction of the porous electrodes 30 between the mutually communicated flow passages 31 of the adjacent flow passage electrodes. The flow passages 31 are communicated by virtue of the overlapping sections, and only lengths of the flow passages 31 are required to be properly increased when the flow passages 31 are formed. A manufacturing method is simple, and the electrolyte can be ensured to smoothly flow in the porous electrode assembly.

As shown in FIG. 2 to FIG. 7, there are one or more flow fields, and an extending direction of each flow passage 31 in each flow field is the same. The flow fields transversely extend or longitudinally extend, and uniform flow pressure is formed on contact surfaces of the flow fields and the porous electrode assembly, thereby forming uniform flow pressure at parts, without any flow field, in the porous electrode assembly and enabling a flow in the porous electrode assembly to uniformly flow.

As shown in FIG. 2, in a preferred embodiment of the disclosure, there is one flow field in the porous electrode assembly, and the flow field is provided on a centre plane of the porous electrode assembly. When one flow field is provided on the centre plane of the porous electrode assembly, the flow field may be provided on a transverse centre plane, and may also be provided on a longitudinal centre plane, and the electrolyte distributed in the porous electrode assembly on two sides of the flow field can uniformly flow under the uniform pressure of the electrolyte in the flow field.

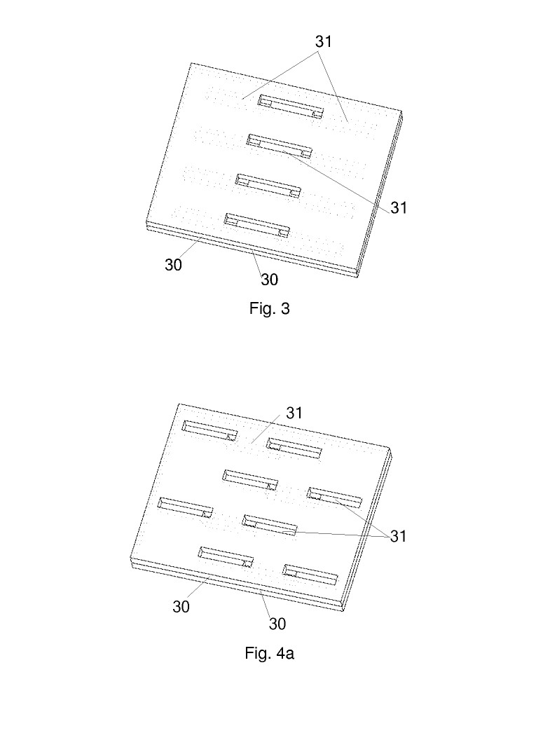

As shown in FIG. 3 to FIG. 7, in a preferred embodiment of the disclosure, there are multiple flow fields in the porous electrode assembly, and the flow fields are arranged in manners as follows: A, each flow field is arranged in parallel, and distances between two ends of each flow field and edges of the porous electrode assembly perpendicular to an extending direction of the flow field are the same; or B, each flow field is arranged in parallel, and adjacent flow fields are staggered along the extending direction of the flow passages 31; or C, each flow field is arranged in parallel with one end open, and opening directions of adjacent flow fields are the same or opposite; or D, the flow fields are divided into multiple flow field groups which are arranged in parallel, each flow field group comprises multiple flow fields, an extending direction of each flow field group is parallel to the extending direction of the flow passages 31 in the flow field group, and the flow fields in adjacent flow field groups are staggered along the extending direction of the flow passages 31; or E, the flow fields are divided into multiple flow field groups which are arranged in parallel, the extending direction of each flow field group is perpendicular to an extending direction of the flow passages 31 in the flow field group, each flow field group comprises multiple flow fields, and the flow fields in each flow field group are staggered along the extending direction of the flow passages 31.

When the flow fields in the porous electrode assembly are arranged in manner A, as shown in FIG. 3, the distances between every two adjacent flow fields may be equal or different, and when the distances between the adjacent flow fields are reduced along a longitudinal flowing direction of the electrolyte, sizes of porous electrode areas between the flow fields are also reduced along the same direction, so that the problems of reduction in liquid pressure and further reduction in a flow velocity of the electrolyte in the porous electrode areas along with the prolonging of a flowing path of the electrolyte and reduction in the flow velocity of the electrolyte are more effectively solved. When manner A is adopted, the electrolyte in the flow fields generates relatively uniform pressure on the porous electrode areas through which the electrolyte intends to flow, so that the electrolyte uniformly flows in the porous electrode assembly. The flow fields may be arranged in a manner of transverse extension as shown in FIG. 3, and may also be arranged in a manner of longitudinal extension, the distances between the adjacent flow fields may be equal or unequal, and the distances between the adjacent flow fields are preferably reduced along a transverse flowing direction of the electrolyte.

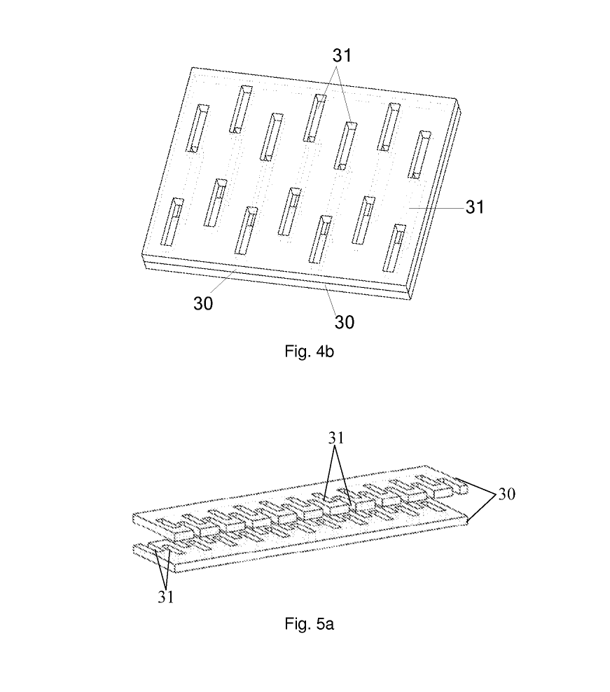

When the flow fields in the porous electrode assembly are arranged in manner B, the transversely extending flow fields are staggered in manner B as shown in FIG. 4a, the distances between the adjacent flow fields may be equal or unequal, the distances of the adjacent flow fields are preferably reduced along the longitudinal flowing direction of the electrolyte, the longitudinally extending flow fields are staggered in manner B as shown in FIG. 4b, the distances between the adjacent flow fields may be equal or unequal, and the distances of the adjacent flow fields are preferably reduced along the transverse flowing direction of the electrolyte. In both manners, certain pressure can be generated for the flowing of the electrolyte between the adjacent flow fields, and under the combined action of the adjacent flow fields, the electrolyte can uniformly flow in the porous electrode assembly.

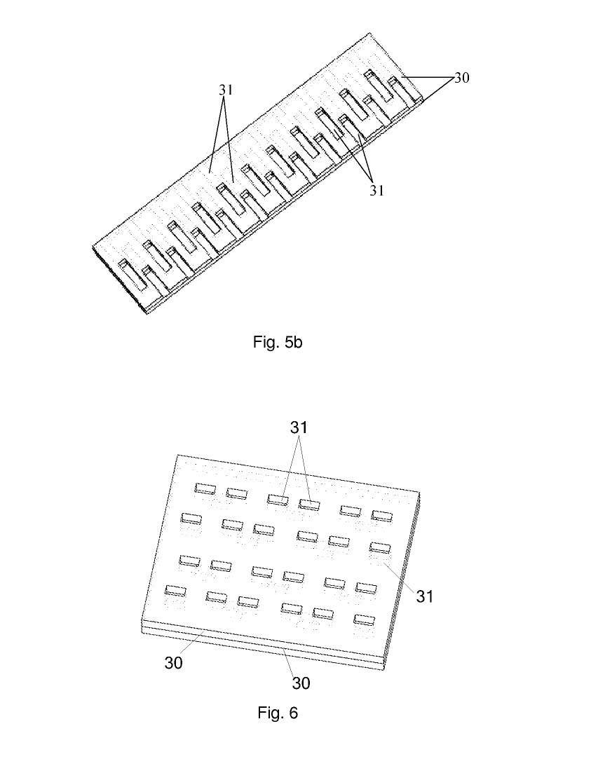

When the flow fields in the porous electrode assembly are arranged in manner C, as shown in FIG. 5a and FIG. 5b, the electrolyte enters the porous electrode assembly from the flow fields with openings, and permeates a solid of the porous electrode assembly from the flow fields; and the electrolyte is divided, so that the flowing uniformity of the electrode in the porous electrode assembly.

When the flow fields in the porous electrode assembly are arranged in manner D, as shown in FIG. 6, advantages of manners A and B are integrated, so that the arrangement of the flow fields in manner D reduces the flow pressure liquid required by the flowing of the electrolyte and realizes the uniform flowing of the electrolyte in the porous electrode assembly.

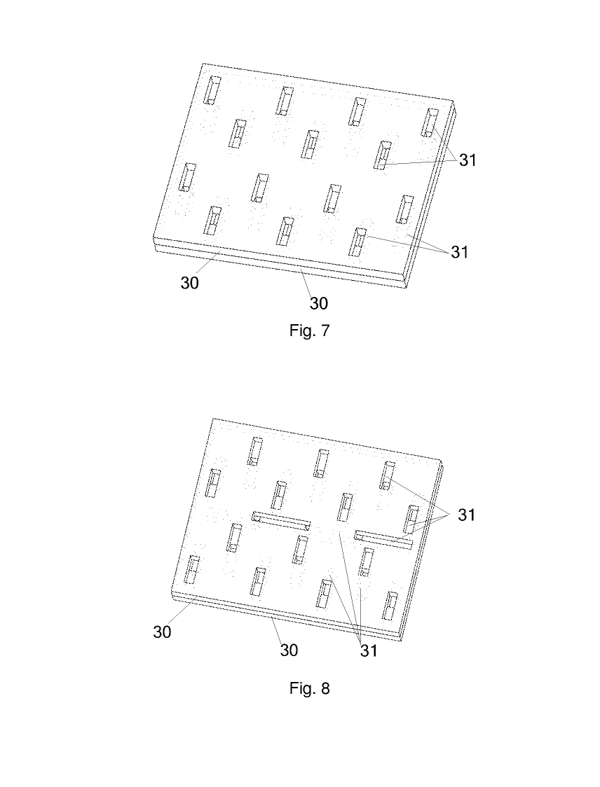

When the flow fields in the porous electrode assembly are arranged in manner E, as shown in FIG. 7, the technical effect of the arrangement manner shown in FIG. 6 may also be achieved when the longitudinally extending flow fields are arranged in manner E.

The flow fields of the porous electrode assembly comprise one or more first flow fields formed by the flow passages 31 with the same extending direction and one or more second flow fields perpendicular to an extending direction of the first flow field. The first flow fields and the second flow fields, which are perpendicular, are integrally provided, so that more uniform flow pressure is generated by the electrolyte in the porous electrode assembly, and the effect that the electrolyte uniformly flows in the porous electrode assembly is better achieved.

As shown in FIG. 8 to FIG. 13b, in another preferred embodiment of the disclosure, the flow fields are arranged in manners as follows: F, there are multiple first flow fields on the porous electrodes 30, the multiple first flow fields are divided into multiple first flow field groups, at least one second flow field is provided between every two adjacent first flow field groups, each first flow field group comprises multiple first flow fields which are arranged in parallel, and adjacent first flow fields are staggered along the extending direction of the flow passages 31 of the first flow fields; or G, there are one or more T-shaped flow field groups on the porous electrodes 30, the T-shaped flow field group comprises a first flow field and a second flow field facing a middle part of the first flow field, second flow field and the first flow field in each T-shaped flow field group are not communicated, and when there are multiple T-shaped flow field groups, in every two adjacent T-shaped flow field groups, the two second flow fields are parallel to each other, the two first flow fields are positioned at different ends of the corresponding second flow fields, and the adjacent T-shaped flow field groups are communicated or not communicated with one another; or H, there are one or more I-shaped flow field groups on the porous electrodes 30, the I-shaped flow field group comprises two first flow fields which are oppositely arranged in parallel and a second flow field of which two ends face middle parts of the two first flow fields respectively, the second flow field is not communicated with the first flow fields, and when there are multiple I-shaped flow field groups, the I-shaped flow field groups are communicated or not communicated with one another; or I, there are one or more Z-shaped flow field groups on the porous electrode assembly, the Z-shaped flow field group comprises two first flow fields and a second flow field, the two first flow fields are provided on two sides of the second flow field respectively, the two first flow fields are communicated with different end parts of the second flow field respectively, and when there are multiple Z-shaped flow field groups, the Z-shaped flow field groups are communicated or not communicated with one another; or J, there are one or more serpentine flow field groups of which two ends are open on the porous electrode assembly, the serpentine flow field group comprises multiple first flow fields and multiple second flow fields, the first flow fields and the second flow fields between the first flow fields and/or second flow fields at openings in the two ends are communicated end to end, and the serpentine flow field groups are communicated or not communicated; or K, there are one or more parallel flow field groups of which two ends are open on the porous electrode assembly, the parallel flow field group comprises two first flow fields and multiple second flow fields, and the second flow fields are provided between the first flow fields, and are communicated with the second flow fields.

When the flow fields in the porous electrode assembly of the disclosure are arranged in manner F, as shown in FIG. 8, the porous electrode assembly is divided into uniform multiple porous electrode areas by the flow passages of the transversely extending second flow fields, and the flow passages of the longitudinally extending first flow fields in each porous electrode area are distributed in parallel, and are mutually staggered, so that a small area for the electrolyte to better flow uniformly is formed in each porous electrode area, and these small areas are combined to form the porous electrode assembly in which the electrolyte is uniformly distributed. When the flow passages of the second flow fields longitudinally extend and the flow passages of the first flow fields transversely extend in FIG. 7, the uniform distribution of the electrolyte in the porous electrode assembly may also be implemented.

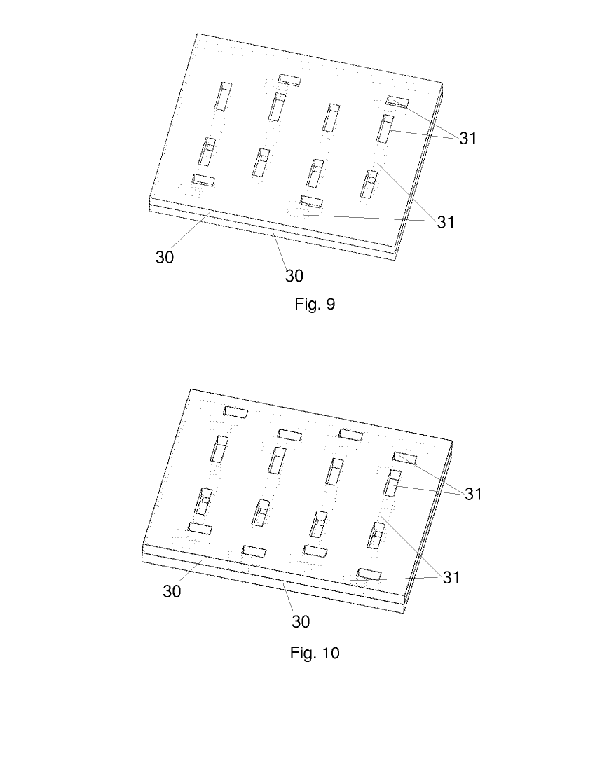

When the flow fields in the porous electrode assembly of the disclosure are arranged in manner G, as shown in FIG. 9, T-shaped and inverted T-shaped flow fields are crosswise provided; in addition, all of the T-shaped flow fields can be arranged in T shapes, and can also be arranged in inverted T shapes; moreover, the distances between the T-shaped first flow fields and the T-shaped second flow fields may be the same or different. Flow pressure around the T shapes is uniform, and moreover, if there are more T shapes, there are more flow fields in the porous electrode assembly, resistance to the flowing of the electrolyte in the porous electrode assembly is lower, and the effect of uniformity of the electrolyte is more easily achieved.

When the flow fields in the porous electrode assembly of the disclosure are arranged in manner H, as shown in FIG. 10, I shapes are distributed as shown in FIG. 10, flow pressure around the I shapes is uniform, and moreover, if there are more I shapes, there are more flow fields in the porous electrode assembly, the resistance to the flowing of the electrolyte in the porous electrode assembly is lower, and the effect of uniformity of the electrolyte is more easily achieved.

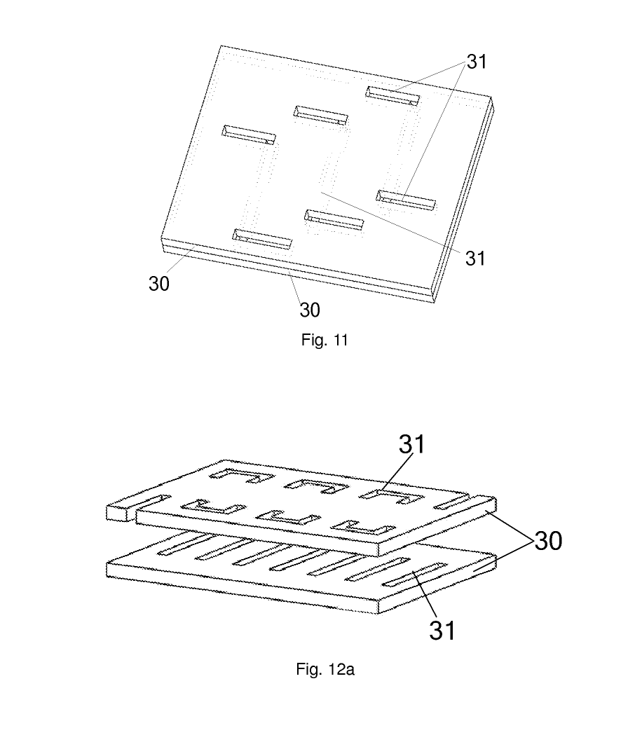

When the flow fields in the porous electrode assembly of the disclosure are arranged in manner I, the Z-shaped flow fields in the porous electrode assembly are provided as shown in FIG. 11, uniform pressure on flow around Z shapes is generated when the electrolyte flows in the Z-shaped flow fields, and moreover, if there are more Z shapes, there are more flow fields in the porous electrode assembly, the resistance to the flowing of the electrolyte in the porous electrode assembly is lower, and the effect of uniformity of the electrolyte is more easily achieved.

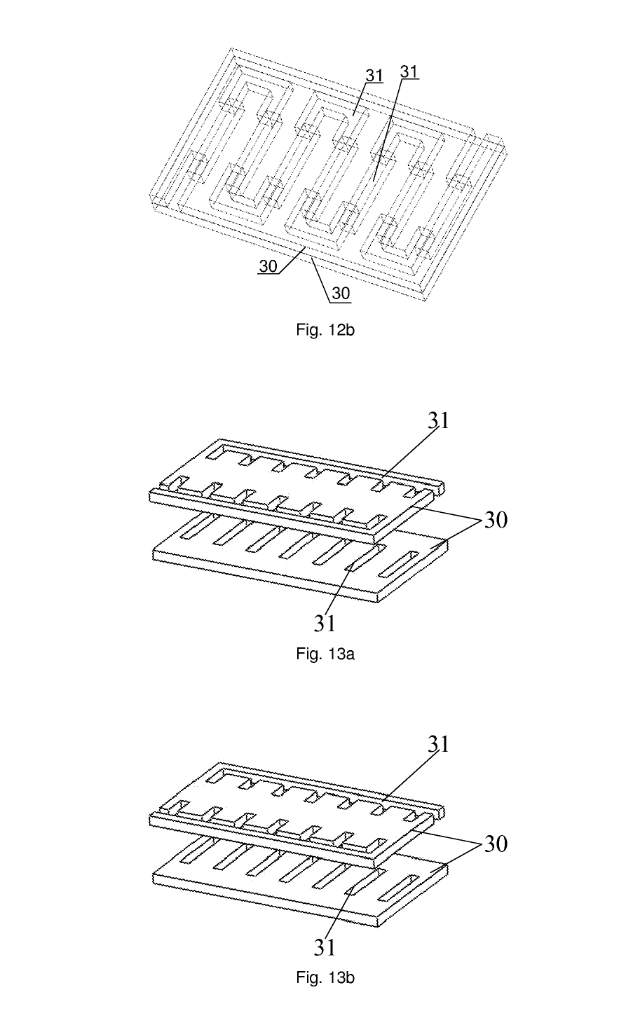

When the flow fields in the porous electrode assembly of the disclosure are arranged in manner J, as shown in FIG. 12a and FIG. 12b, the electrolyte enters the porous electrode assembly from the flow passages 31 of the flow passage electrodes positioned at the upper part, enters the lower flow passage electrodes along the flow passages 31, and then flows into the upper flow passage electrodes along the flow passages 31, and the electrolyte permeates solid parts of the porous electrode assembly at the same time of flowing along the flow fields of the porous electrode assembly, so that the electrolyte in the whole porous electrode assembly tends to flow uniformly, and the phenomenon of concentration polarization caused by the flowing non-uniformity of the electrolyte is improved.

When the flow fields in the porous electrode assembly of the disclosure are arranged in manner K, as shown in FIG. 13a to FIG. 13b, the electrolyte enters the porous electrode assembly from the first flow fields, flows to each second flow field, flows to the porous electrodes 30 of each layer along the second flow fields, and flows out of the porous electrode assembly along the first flow fields, and the electrolyte permeates solids of the porous electrode assembly at the same time of flowing along the flow fields, so that the effect of uniform flowing of the electrolyte can also be achieved.

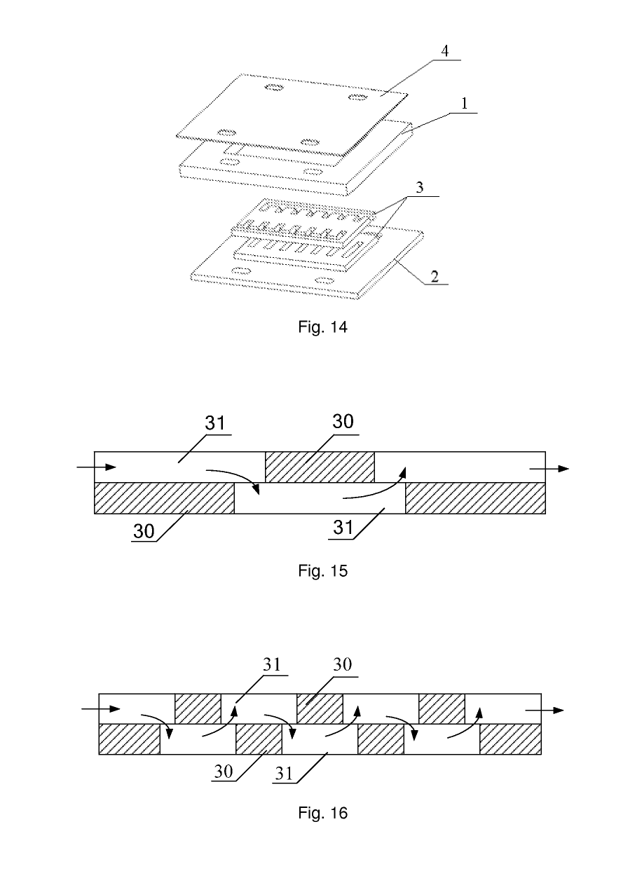

As shown in FIG. 14, in another typical implementation mode of the disclosure, a flow half-cell is provided, the flow half-cell comprising a flow frame 1, a porous electrode assembly 3 and a bipolar plate 2, wherein the flow frame 1 is provided with borders 11 and an electrode accommodation cavity formed by the borders 11, and an electrolyte inlet and an electrolyte outlet are formed in the borders 11; the porous electrode assembly 3 is embedded into the electrode accommodation cavity of the flow frame 1, and is communicated with the electrolyte inlet and the electrolyte outlet, and the porous electrode assembly 3 is the abovementioned porous electrode assembly; and the bipolar plate 2 is provided on one side of the flow frame 1 and, and is parallel to the porous electrode assembly 3.

According to the flow half-cell with such a structure, the porous electrode assembly 3 is communicated with the electrolyte inlet 12 and electrolyte outlet 13 of the flow frame 1, so that an electrolyte can be rapidly delivered into the porous electrode assembly 2, and flows and permeates in stacked porous electrodes 30 of the porous electrode assembly 3 through flow fields of the porous electrode assembly 3. Due to the existence of the flow fields, resistance during the flowing of the electrolyte in the porous electrode assembly 3 is reduced, uniformity of flow is improved, mass transfer efficiency of the electrolyte in the porous electrode assembly is improved, concentration polarization and flow pressure drop are reduced, and charging and discharging efficiency of the flow half-cell is improved.

In order to make those skilled in the art easily understand the structure of the flow half-cell of the disclosure, description about the structure of the flow half-cell shown in FIG. 14 is given with examples, and is not intended to limit the structural design of the flow half-cell of the disclosure, a positive electrolyte inlet is positioned in a left lower corner of the flow frame 1, and a positive electrolyte outlet is positioned in a right upper corner of the flow frame 1 (not shown in FIG. 14).

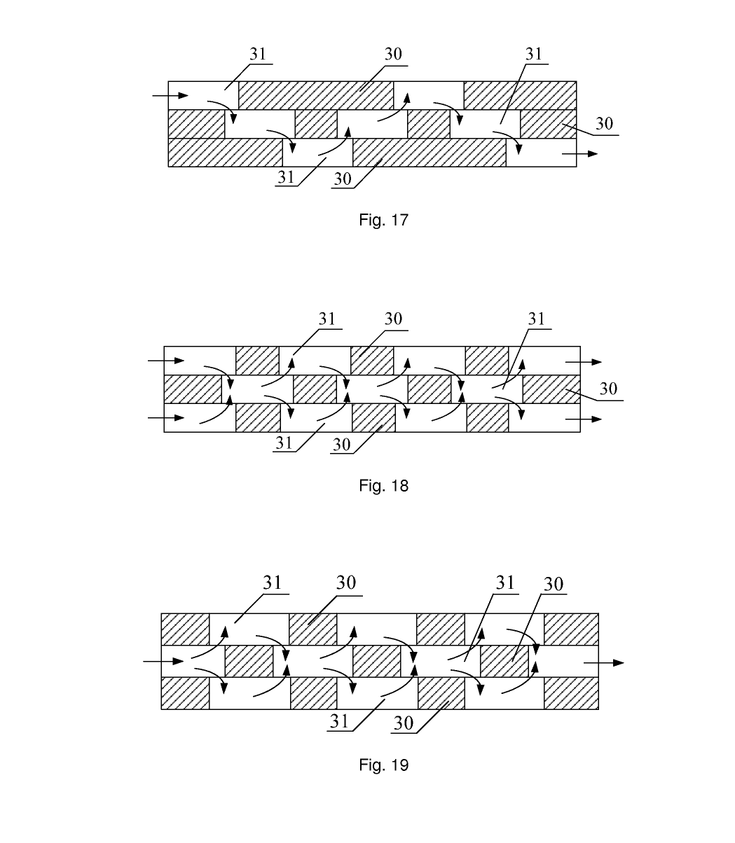

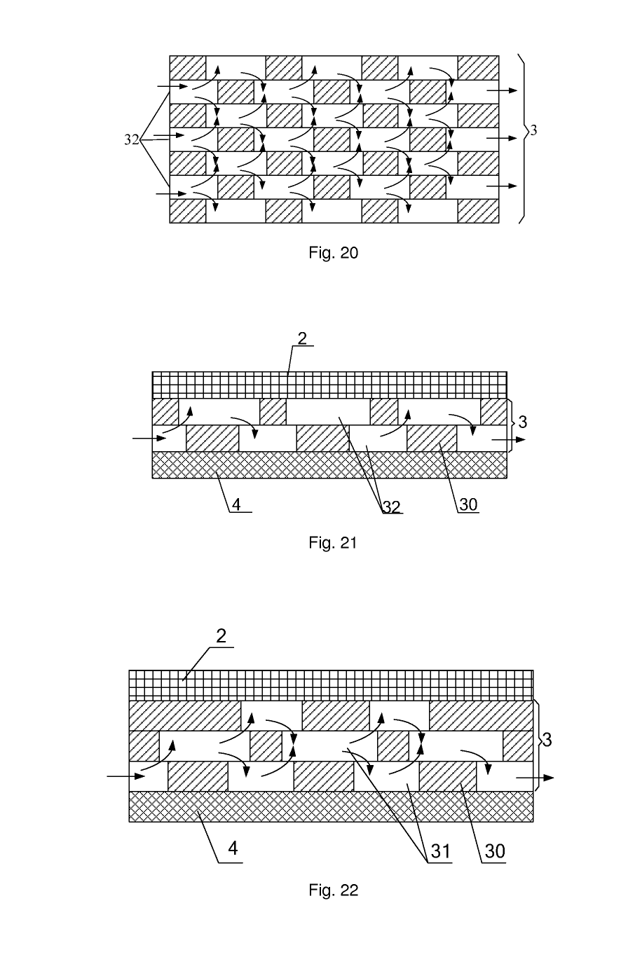

Positions of the electrolyte inlet and electrolyte outlet of the flow frame 1 may be properly changed according to actual needs, and as shown in FIG. 15 to FIG. 22, the arrangement of the electrolyte inlet and the electrolyte outlet and the arrangement of flow passages 31 can be matched to control a position and direction of the electrolyte flowing into the porous electrode assembly 3 and a position and direction of the electrolyte flowing out of the porous electrode assembly 3.

As shown in FIG. 15 to FIG. 22, in a preferred embodiment of the disclosure, there are overlapping sections overlapping in a stacking direction of the porous electrodes 30 of the porous electrode assembly 3 between the mutually communicated flow passages 31 of adjacent flow passage electrodes of the porous electrode assembly 3. The flow passages 31 are communicated by virtue of the overlapping sections, and only lengths of the flow passages 31 are required to be properly increased when the flow passages 31 are formed. A manufacturing method is simple, and the electrolyte can be ensured to smoothly flow in the porous electrode assembly.

As shown in FIG. 21 and FIG. 22, in the porous electrode assembly 3, extending length of the overlapping section for the electrolyte to flow to the porous electrodes 30 far away from the bipolar plate 2 are greater than extending length of the overlapping section for the electrolyte to flow to the porous electrodes 30 close to the bipolar plate 2.

In a charging and discharging reaction process, reaction efficiency of the porous electrodes 30 far away from the bipolar plate 2 is higher, so that the flow passages 31 of the porous electrodes 30 far away from the bipolar plate 2 is preferably shorter, and the solid parts of the porous electrodes 30 are more; and similarly, the reaction efficiency of the porous electrodes 30 close to the bipolar plate 2 in the charging and discharging reaction process is lower, preferably, the flow passages 31 of the porous electrodes 30 close to the bipolar plate 2 is longer, and the solid parts of the porous electrodes are fewer. By such a structural design, the flow of the electrolyte in the flow passages 31 of the porous electrodes 30 far away from the bipolar plate 2 is larger, and the flow of the electrolyte in the flow passages of the porous electrodes 30 close to the bipolar plate 2 is smaller, so that more electrolyte and reaction ions are provided in the porous electrodes 30 with higher reaction efficiency, reaction and utilization efficiency of the electrodes is finally improved, and efficiency of the half-cell is further improved.

In a preferred embodiment of the disclosure, the flow borders 1 of the flow half-cell comprises a first border and a second border, which are opposite to each other, the electrolyte inlet is formed in the first border, the electrolyte outlet is formed in the second border, and gaps are formed between the porous electrode assembly 3 and the first border and the second border.

the gaps are formed between the first border with the electrolyte inlet 12 and the second border with the electrolyte outlet and the porous electrode assembly 3, and by virtue of the gaps, the electrolyte flowing into the porous electrode assembly from the electrolyte inlet is uniformly delivered into the flow passages of the porous electrodes 30 or permeates in the porous electrodes 30, and then flows between the porous electrodes 30 of the porous electrode assembly 3 to realize high-efficiency charging and discharging reaction.

In the disclosure, in order to further improve flowability of the electrolyte between the porous electrode assembly 3 and the flow frame 1, preferably, a flow field of the porous electrode assembly 3 is provided with an opening, and is perpendicular to the first border and the second border, and the gaps communicate the electrolyte inlet with the flow field and communicate the electrolyte outlet with the flow field. When the flow field of the porous electrode assembly is provided with the opening, all of the flow fields arranged in manner C shown in FIG. 5a, FIG. 5b, FIG. 6a and FIG. 6b, the flow fields arranged in manner J shown in FIG. 13a and FIG. 13b and the flow fields arranged in manner K shown in FIG. 14a and FIG. 14b are provided with openings, and the electrolyte flowing into the porous electrode assembly from the electrolyte inlet simultaneously enters the flow fields with the openings by virtue of the gaps perpendicular to the flow fields, so that the flowing uniformity of the electrolyte in the porous electrodes 30 is improved; and moreover, the reacted electrolyte is timely delivered out of the porous electrodes 30 by virtue of the gaps and the electrolyte outlet, so that the charging and discharging efficiency of the flow half-cell is improved.

In another preferred embodiment of the disclosure, an electrolyte flow guide inlet and an electrolyte flow guide outlet, which correspond to the electrolyte inlet and the electrolyte outlet, are formed in the bipolar plate 2 of the flow half-cell. The electrolyte flow guide inlet and the electrolyte flow guide outlet, which correspond to the electrolyte inlet and the electrolyte outlet, are formed in the bipolar plate 2, and then the electrolyte may sequentially pass through the electrolyte flow guide inlet, the electrolyte inlet, the porous electrode assembly 3, the electrolyte outlet and the electrolyte flow guide outlet, so that a path along which the electrolyte flows into the flow half-cell and flows out of the flow half-cell is shortened as much as possible, and the degree of integration and structural compactness of the flow half-cell are improved.

A positive electrolyte inlet, a positive electrolyte outlet, a negative electrolyte outlet and a negative electrolyte outlet can be simultaneously formed in the flow frame 1 of the flow half-cell of the disclosure, a positive electrolyte flow guide inlet corresponding to the positive electrolyte inlet, a positive electrolyte flow guide outlet corresponding to the positive electrolyte outlet, a negative electrolyte flow guide inlet corresponding to the negative electrolyte inlet and a negative electrolyte flow guide outlet corresponding to the negative electrolyte outlet can be simultaneously formed in the bipolar plate 2, and a flowing positive electrolyte is isolated from a flowing negative electrolyte in a currently common manner of matching a sealing ring and a sealing groove.

In another typical implementation mode of the disclosure, a flow cell stack is provided, which comprises one or more positive half-cells, one or more negative half-cells and an ion exchange membrane 4 provided between the positive half-cell and the negative half-cell, wherein the positive half-cell and the negative half-cell are abovementioned flow half-cell, and bipolar plates 2 of the flow half-cells are provided far away from the ion exchange membrane 4.

The flow cell stack is provided with the flow half-cells of the disclosure, so that the flow cell stack also has higher charging and discharging efficiency.

The above is only the preferred embodiment of the disclosure and not intended to limit the disclosure. For those skilled in the art, the disclosure may have various modifications and variations. Any modifications, equivalent replacements, improvements and the like made within the spirit and principle of the disclosure shall fall within the scope of protection of the disclosure.

1. A porous electrode assembly, comprising multiple porous electrodes which are stacked, wherein at least two porous electrodes are flow passage electrodes with flow passage, and a part of flow passages of at least two flow passage electrodes are mutually communicated to form a flow field.

2. The porous electrode assembly according to claim 1, wherein there are overlapping sections overlapping in a stacking direction of the porous electrodes between mutually communicated flow passages of adjacent flow passage electrodes.

3. The porous electrode assembly according to claim 1, wherein there are one or more flow fields, and an extending direction of each flow passage in each flow field is the same.

4. The porous electrode assembly according to claim 3, wherein there is one flow field, and the flow field is provided on a centre plane of the porous electrode assembly.

5. The porous electrode assembly according to claim 3, wherein there are multiple flow fields, and the flow fields are arranged in manners as follows:
A, each flow field is arranged in parallel with two ends closed, and distances between the two ends of each flow field and edges of the porous electrode assembly perpendicular to an extending direction of the flow field are the same; or
B, each flow field is arranged in parallel with two ends closed, and adjacent flow fields are staggered along the extending direction of the flow passages; or
C, each flow field is arranged in parallel with one end open, and opening directions of adjacent flow fields are the same or opposite; or
D, the flow fields are divided into multiple flow field groups which are arranged in parallel, each flow field group comprises multiple flow fields, an extending direction of each flow field group is parallel to the extending direction of the flow passages in the flow field group, and the flow fields in adjacent flow field groups are staggered along the extending direction of the flow passages; or
E, the flow fields are divided into multiple flow field groups which are arranged in parallel, each flow field group comprises multiple flow fields, an extending direction of each flow field group is perpendicular to the extending direction of the flow passages in the flow field group, and the flow fields in each flow field group are staggered along the extending direction of the flow passages.

6. The porous electrode assembly according to claim 1, wherein the flow fields comprise one or more first flow fields formed by the flow passages with the same extending direction and one or more second flow fields perpendicular to an extending direction of the first flow field.

7. The porous electrode assembly according to claim 6, wherein the flow fields are arranged in manners as follows:
F, there are multiple first flow fields on the porous electrode assembly, the multiple first flow fields are divided into multiple first flow field groups, at least one second flow field is provided between every two adjacent first flow field groups, each first flow field group comprises multiple first flow fields which are arranged in parallel, and adjacent first flow fields are staggered along the extending direction of the flow passages of the first flow fields; or
G, there are one or more T-shaped flow field groups on the porous electrode assembly, the T-shaped flow field group comprises a first flow field and a second flow field facing a middle part of the first flow field, the second flow field and the first flow field in the T-shaped flow field group are not communicated, and when there are multiple T-shaped flow field groups, in every two adjacent T-shaped flow field groups, two second flow fields are parallel to each other, two first flow fields are positioned at different ends of the corresponding second flow fields, and the adjacent T-shaped flow field groups are communicated or not communicated with one another; or
H, there are one or more I-shaped flow field groups on the porous electrode assembly, the I-shaped flow field group comprises two first flow fields which are oppositely arranged in parallel and a second flow field of which two ends face middle parts of the two first flow fields respectively, the second flow field is not communicated with the first flow fields, and when there are multiple I-shaped flow field groups, the I-shaped flow field groups are communicated or not communicated with one another; or
I, there are one or more Z-shaped flow field groups on the porous electrode assembly, the Z-shaped flow field group comprises two first flow fields and a second flow field, the two first flow fields are provided on two sides of the second flow field respectively, the two first flow fields are communicated with different end parts of the second flow field respectively, and when there are multiple Z-shaped flow field groups, the Z-shaped flow field groups are communicated or not communicated with one another; or
J, there are one or more serpentine flow field groups of which two ends are open on the porous electrode assembly, the serpentine flow field group comprises multiple first flow fields and multiple second flow fields, the first flow fields and the second flow fields between the first flow fields and/or second flow fields at openings in the two ends are communicated end to end, and the serpentine flow field groups are communicated or not communicated; or
K, there are one or more parallel flow field groups of which two ends are open on the porous electrode assembly, the parallel flow field group comprises two first flow fields and multiple second flow fields, and the second flow fields are provided between the first flow fields, and are communicated with the second first flow fields.

8. A flow half-cell, comprising:
a flow borders provided with borders and an electrode accommodation cavity formed by the borders, electrolyte inlet and electrolyte outlet being formed in the borders;
a porous electrode assembly, embedded into the electrode accommodation cavity of the flow borders and communicated with the electrolyte inlet and the electrolyte outlet, the porous electrode assembly being the porous electrode assembly according to claim 1; and
a bipolar plate, provided on one side of the flow borders and in parallel with the porous electrode assembly.

9. The flow half-cell according to claim 8, wherein there are overlapping sections overlapping in a stacking direction of porous electrodes of the porous electrode assembly between mutually communicated flow passages of adjacent flow passage electrodes of the porous electrode assembly.

10. The flow half-cell according to claim 9, wherein in the porous electrode assembly, extending length of the overlapping section for an electrolyte to flow to the porous electrodes far away from the bipolar plate are greater than extending length of the overlapping section for the electrolyte to flow to the porous electrodes close to the bipolar plate.

11. The flow half-cell according to claim 9, wherein the flow frame comprises a first border and a second border, which are opposite to each other, the electrolyte inlet is formed in the first border, the electrolyte outlet is formed in the second border, and gaps are formed between the porous electrode assembly and the first border and the second border.

12. The flow half-cell according to claim 11, wherein a flow field of the porous electrode assembly is provided with an opening, and is perpendicular to the first border and the second border, and the gaps communicate the electrolyte inlet with the flow field and communicate the electrolyte outlet with the flow field.

13. The flow half-cell according to claim 8, wherein an electrolyte flow guide inlet and an electrolyte flow guide outlet, which correspond to the electrolyte inlet and the electrolyte outlet, are formed in the bipolar plate.

14. A flow cell stack, comprising one or more positive half-cells, one or more negative half-cells and an ion exchange membrane provided between the positive half-cell and the negative half-cell, wherein the positive half-cell and the negative half-cell are the flow half-cell according to claim 8, and bipolar plates of the flow half-cells are provided far away from the ion exchange membrane.

15. The porous electrode assembly according to claim 2, wherein there are one or more flow fields, and an extending direction of each flow passage in each flow field is the same.

16. The porous electrode assembly according to claim 2, wherein the flow fields comprise one or more first flow fields formed by the flow passages with the same extending direction and one or more second flow fields perpendicular to an extending direction of the first flow field.

17. A flow half-cell, comprising:
a flow borders, provided with borders and an electrode accommodation cavity formed by the borders, electrolyte inlet and electrolyte outlet being formed in the borders;
a porous electrode assembly, embedded into the electrode accommodation cavity of the flow borders and communicated with the electrolyte inlet and the electrolyte outlet, the porous electrode assembly being the porous electrode assembly according to claim 2; and
a bipolar plate, provided on one side of the flow borders and in parallel with the porous electrode assembly.

18. A flow half-cell, comprising:
a flow borders, provided with borders and an electrode accommodation cavity formed by the borders, electrolyte inlet and electrolyte outlet being formed in the borders;
a porous electrode assembly, embedded into the electrode accommodation cavity of the flow borders and communicated with the electrolyte inlet and the electrolyte outlet, the porous electrode assembly being the porous electrode assembly according to claim 3; and
a bipolar plate, provided on one side of the flow borders and in parallel with the porous electrode assembly.

19. The flow half-cell according to claim 9, wherein an electrolyte flow guide inlet and an electrolyte flow guide outlet, which correspond to the electrolyte inlet and the electrolyte outlet, are formed in the bipolar plate.

20. A flow cell stack, comprising one or more positive half-cells, one or more negative half-cells and an ion exchange membrane provided between the positive half-cell and the negative half-cell, wherein the positive half-cell and the negative half-cell are the flow half-cell according to claim 9, and bipolar plates of the flow half-cells are provided far away from the ion exchange membrane.
